(19) United States
(12) Patent Application Publication
(10) Pub. No.: US 2019/0182437 A1
(43) Pub. Date: Jun. 13, 2019

(54) A System, Controller, Method and Computer Program for Image Processing

(71) Applicant: Nokia Technologies Oy, Espoo (FI)

(72) Inventor: Markku OIKKONEN, Helsinki (FI)

(21) Appl. No.: 16/325,758

(22) PCT Filed: Aug. 19, 2016
(86) PCT No.: PCT/FI2016/050567

§ 371 Date: Feb. 15, 2019

(51) Int. Cl. H04N 5/272; H04N 5/247; H04N 5/232

(52) U.S. Cl. CPC H04N 5/272; H04N 5/23299; H04N 5/247

(57) ABSTRACT

A system including at least a first camera configured to have a first unobstructed field of view volume and to capture a first image defined by a first in-use field of view volume; at least a second camera configured to capture a second image defined by a second in-use field of view volume, and positioned within the first unobstructed field of view volume of the first camera but not within the first in-use field of view volume of the first camera in front of an obstructing object; and a controller configured to define a new image by using at least a second image portion of the second image captured by the second camera instead of at least a portion of the first image captured by the first camera.

### TECHNOLOGICAL FIELD

Embodiments of the present invention relate to a system, controller, method and computer program for image processing. In particular, they relate to the replacement of an unwanted portion of an image.

### BACKGROUND

The Nokia OZO™ camera system is an example of a system that has a plurality of cameras that simultaneously capture images of a scene from different perspectives. The resultant images can be combined to give a panoramic image.

As a result of the number of simultaneously operating cameras, the effective field of view associated with the system and the panoramic image is large. It is more probable that an unwanted object will be captured within the panoramic image.

It would be desirable to address this problem.

### BRIEF SUMMARY

According to various, but not necessarily all, embodiments of the invention there is provided a system comprising: at least a first camera configured to have a first unobstructed field of view volume and to capture a first image defined by a first in-use field of view volume; at least a second camera configured to capture a second image defined by a second in-use field of view volume, and positioned within the first unobstructed field of view volume of the first camera; a controller configured to define a new image by using at least a second image portion of the second image captured by the second camera instead of at least a portion of the first image captured by the first camera.

According to various, but not necessarily all, embodiments of the invention there is provided a system comprising:

at least a first camera configured to have a first unobstructed field of view volume and to capture a first image defined by a first in-use field of view volume;

at least a second camera configured to capture a second image defined by a second in-use field of view volume, and positioned within the first unobstructed field of view volume of the first camera but not within the first in-use field of view volume of the first camera in front of an obstructing object;

a controller configured to define a new image by using at least a second image portion of the second image captured by the second camera instead of at least a portion of the first image captured by the first camera.

According to various, but not necessarily all, embodiments of the invention there is provided a controller configured to define a new image by using, instead of at least a portion of a first image including the foreground of a scene, at least a second image portion of a second image not including the foreground of the scene, wherein the first image is provided by a first camera and has a relatively narrow first field of view and includes a foreground, a middleground and a background of a scene, and wherein the second image is provided by a second camera different to the first camera and has a relatively wide second field of view and has only the middleground and the background of the scene.

According to various, but not necessarily all, embodiments of the invention there is provided a controller configured to define a new image by using, instead of at least a portion of a first image including the foreground of a scene, at least a second image portion of a second image not including the foreground of the scene, wherein the first image includes a foreground, a middleground and a background of a scene, and wherein the second image includes only the middleground and the background of the scene, wherein the controller is configured to compensate the second image portion of the second image to adjust for a difference in a position and a field of view for image capture of the first image and a position and a field of view for image capture of the second image.

According to various, but not necessarily all, embodiments of the invention there is provided a method comprising: creating a new image by using, instead of at least a portion of a first image including the foreground of a scene, at least a second image portion of a second image not including the foreground of the scene, wherein the first image is provided by a first camera and has a relatively narrow first field of view and includes a foreground, a middleground and a background of a scene, and wherein the second image is provided by a second camera different to the first camera and has a relatively wide second field of view and has only the middleground and the background of the scene.

According to various, but not necessarily all, embodiments of the invention there is provided a method comprising creating a new image by using, instead of at least a portion of a first image including the foreground of a scene, at least a second image portion of a second image not including the foreground of the scene, wherein the first image includes a foreground, a middleground and a background of a scene, and wherein the second image incudes only the middleground and the background of the scene, and compensating the second image portion of the second image to adjust for a difference in a position and a field of view for image capture of the first image and a position and a field of view for image capture of the second image.

According to various, but not necessarily all, embodiments of the invention there is provided examples as claimed in the appended claims.

### BRIEF DESCRIPTION

For a better understanding of various examples that are useful for understanding the detailed description, reference will now be made by way of example only to the accompanying drawings in which:

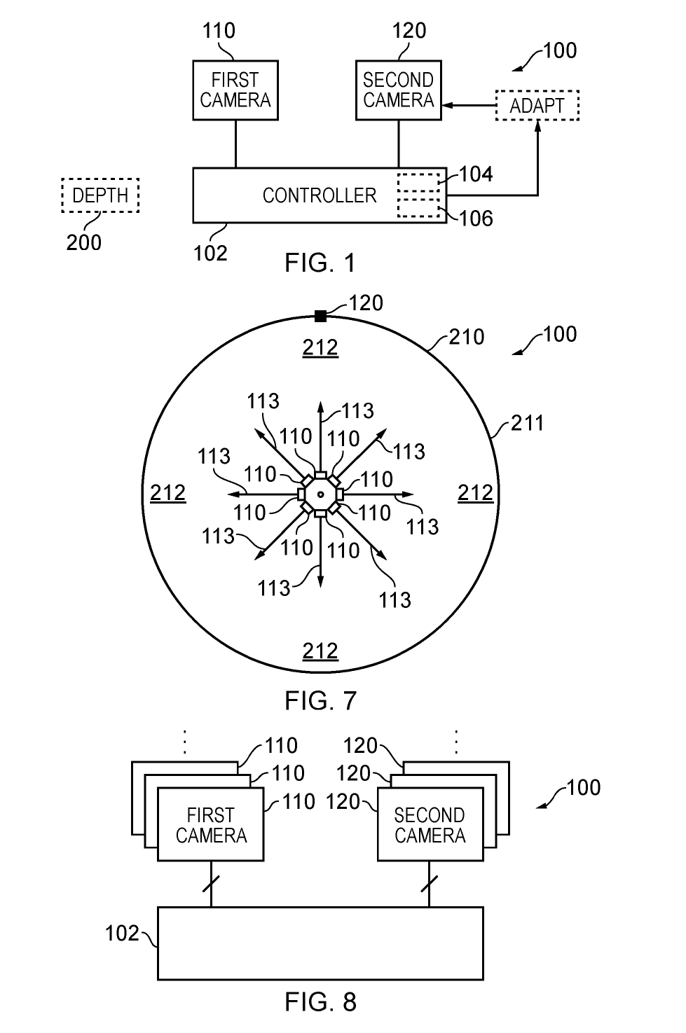

FIG. 1 illustrates an example of a system 100 comprising: a first camera 110; a second camera 120 and a controller 102;

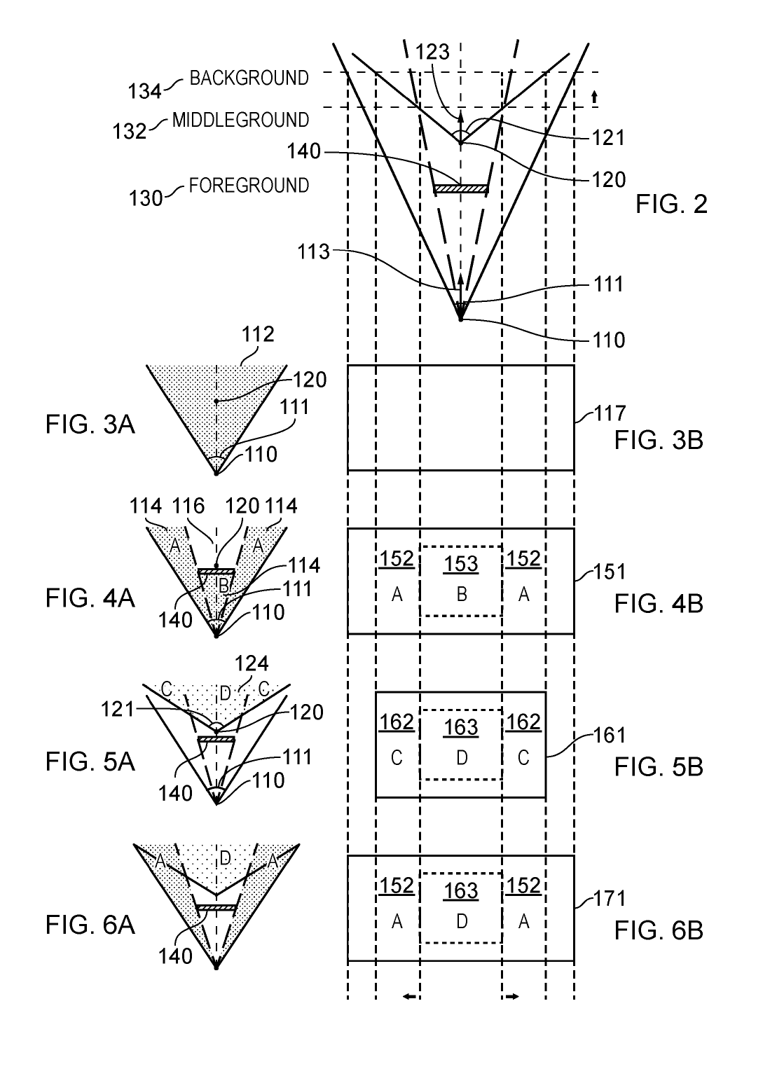

FIG. 2 illustrates an example, in cross-section, in which a first field of view 111 of the first camera 110 overlaps with but is not the same as a second field of view 121 of the second camera 120;

FIG. 3A illustrates an example, in cross-section, of a first unobstructed field of view volume 112 and FIG. 3B illustrates a notional image 117 that would be captured using the first unobstructed field of view volume 112;

FIG. 4A illustrates an example, in cross-section, of a first in-use field of view volume 114 and

FIG. 4B illustrates the first image 151 that is captured by the first camera 110 using the first in-use field of view volume 114;

FIG. 5A illustrates an example, in cross-section, of a second in-use field of view volume 124 and FIG. 5B illustrates the second image 161 that is captured by the second camera 120 using the second in-use field of view volume 124;

FIG. 6A illustrates an example, in cross-section, of a composite field of view volume comprising simultaneously the first in-use field of view volume 114 and the second in-use field of view volume 124 and FIG. 6B illustrates an image 171 defined by the composite field of view volume;

FIG. 7 illustrates an example, in cross-section, of a system 100 in which the second camera 120 is mounted on a rail system 210;

FIG. 8 illustrates an example of the system 100 that has multiple first cameras 110 and multiple second cameras 120;

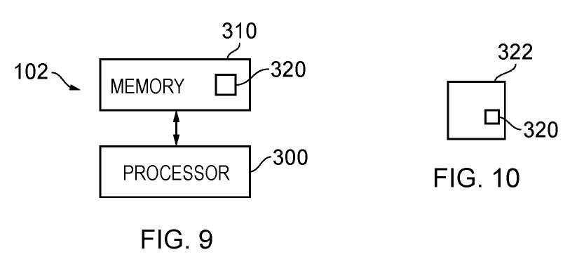

FIG. 9 illustrates an example of the controller 102; and

FIG. 10 illustrates an example of a record carrier comprising a computer program.

### DEFINITIONS

“Field of view” is a two dimensional angle in three-dimensional space that a viewed scene subtends at an origin point. It may be expressed as a single component in a spherical co-ordinate system (steradians) or as two orthogonal components in other co-ordinate systems such as apex angles of a right pyramid at the origin point in a Cartesian co-ordinate system.

“Field of view volume” is the three dimensional space confined by the limiting angles of the “field of view”.

“Foreground” in relation to a scene is that part of the scene nearest to the origin point. “Background” in relation to a scene is that part of the scene furthest from the origin point. “Middleground” in relation to a scene is that part of the scene that is neither foreground nor back ground.

The term ‘size’ is intended to be a vector quantity defining spatial dimensions as vectors. Similarity of size requires not only similarity of scalar area but also of shape and orientation (form).

### DETAILED DESCRIPTION

In at least some of the examples that follow, a foreground portion of a scene that is captured by a first camera 110 in a first image 1510 and has a corresponding unwanted image portion 153 in the first image 151 is replaced by some or all of a second image or a modification of the second image 161 to create a new image 171. The second image 161 is captured by a second camera 120 that is in advance (in front of) the first camera 110 within the scene and does not image the unwanted foreground portion of the scene.

Replacement of an unwanted image portion 153 in the first image 151 by some or all of a second image includes the replacement of the unwanted image portion 153 in the first image 151 by unmodified content of some or all of the second image. Replacement of an unwanted image portion 153 in the first image 151 by some or all of a second image includes the replacement of the unwanted image portion 153 in the first image 151 by modified content of some or all of the second image. As an example, content may be modified to correct for different perspective and/or distortion.

The first image 151 and the second image 161 may be still images or video images.

The new image 171 may be a still image or a video image. It should be appreciated that where the first image 151 and the second image 161 are video images, a new image 171 may be generated for each frame of video.

The generation of the new image 171 may be done live, in real time, while shooting and capturing the images, or in post-production, editing that takes places after the shooting.

FIG. 1 illustrates an example of a system 100 comprising: a first camera 110; a second camera 120 and a controller 102.

In some but not necessarily all examples there may be multiple first cameras 110 and/or multiple second cameras 120.

The operation of the system 100 can be understood with reference to FIG. 2. FIG. 2 illustrates an example in which a first field of view 111 of the first camera 110 overlaps with but is not the same as a second field of view 121 of the second camera 120. The first field of view has at its centre a first optical axis 113 and the second field of view has at its centre a second optical axis 123.

In the example illustrated the first optical axis 113 and the second optical axis 123 are aligned along a common single axis, however, in other examples they may be parallel but not off-set, in other examples they may be nonparallel.

In the example illustrated the second camera 120 is displaced relative to the first camera 110 along the first optical axis 113, however, the first camera 110 may be located at a different position.

The first field of view 111 defines a first unobstructed field of view volume 112 as illustrated in FIG. 3A. This is the field of view volume that would exist if the object 140 were absent (an unobstructed field of view volume is a volume of space that the camera sensor is capable of capturing when the space has no obstructions). The notional image 117 that would be captured using the first unobstructed field of view volume 112, if it existed, is illustrated in FIG. 3B.

Where reference is made to an or the object 140 it should be appreciated that the object may be a single entity or multiple entities. Where an object is multiple entities some or all of these entities may overlap in a field of view and/or they may be distinct and separate in a field of view.

The first field of view 111 also defines (together with the object 140) a first in-use field of view volume 114 as illustrated in FIG. 4A. This is the field of view volume that actually exists with the object 140 present (an in-use field of view volume is the volume of space that the camera sensor is actually detecting in-use when there are obstructions). The first image 151 that is captured by the first camera 110 using the first in-use field of view volume 114 is illustrated in FIG. 4B.

The second field of view 121 defines a second in-use field of view volume 124 as illustrated in FIG. 5A. This is the field of view volume that actually exists with the object 140 present. The second image 161 that is captured by the second camera 120 using the second in-use field of view volume 124 is illustrated in FIG. 5B.

In the illustrated examples, the first field of view 111 of the first camera 110 is narrower than the second field of view 121 of the second camera 120. In some examples, the field of view is a solid angle through which detector is sensitive. In other examples the field of view is defined by a vertical field of view and a horizontal field of view. In the illustrated examples, the horizontal component (angle) of the first field of view 111 of the first camera 110 is narrower (smaller) than the horizontal component (angle) of the second field of view 121 of the second camera 120.

FIG. 6A illustrates simultaneously the first in-use field of view volume 114 and the second in-use field of view volume 124. This is a composite field of view volume formed by the union of the first in-use field of view volume 114 and the second in-use field of view volume 124. The image 171 illustrated in FIG. 6B is a new image 171 defined by the composite field of view volume. Where the first in-use field of view volume 114 and the second in-use field of view volume 124 intersect a choice may be made whether to use the first in-use field of view volume 114 or the second in-use field of view volume 124 to define that portion of the new image 171.

It should be appreciated that each of FIGS. 2, 3B, 4B, 5B and 6B are illustrated at the same relative scale. Each of the images in FIGS. 3B, 4B, 5B and 6B are aligned in register with the other ones of FIGS. 2, 3B, 4B, 5B and 6B. In this example, in register, means that the pixels of the images are aligned vertically in the page. This allows a direct comparison to be made between the size of images and the size of image portions.

It will be appreciated that in this example, but not necessarily all examples, that the size of the new image 171 is the same size as the first image 151.

Referring back to FIG. 1, the first camera 110 is configured to have a first unobstructed field of view volume 112 and to capture a first image 151 defined by a first in-use field of view volume 114. The second camera 120 is configured to capture a second image 161 defined by a second in-use field of view volume 124.

The second camera 120 is positioned within the first unobstructed field of view volume 112 of the first camera 110.

In some examples, the second camera 120 is positioned within the first unobstructed field of view volume 112 of the first camera 110but not within the first in-use field of view volume 114 of the first camera 110 in front of an obstructing object 140 That is possible for the second camera 120 to be or to be a part of the obstructing object 140 so that it is visible or partly visible to (captured by) the first camera. It is also possible for the second camera 120 to be behind the obstructing object 140 so that it is not visible to (not captured by) the first camera. However, the second camera 120 is not within the first in-use field of view volume 114 of the first camera 110 other than as an obstructing object 140.

The controller 102 is configured to define the new image 171 by using at least a second image portion 163 of the second image 161 captured by the second camera 120 instead of at least a portion 153 of the first image 151 captured by the first camera 110.

As illustrated in FIG. 6B, in some examples, the new image may be a composite image comprising at least a first image portion 152 of the first image 151 captured by the first camera 110 and at least a second image portion 163 of the second image 161 captured by the second camera 120.

In the example illustrated, the new image 171 is a composite image including a first image portion 152 of the first image 151 (A) but not including a second image portion 153 of the first image 151 (B) and including a second image portion 163 of the second image 161 (D) but not including a first image portion 162 of the second image 161 (C).

It will be appreciated that the size of the second image portion 153 of the first image 151 that is replaced by the second image portion 163 of the second image 161 has the same size as the second image portion 163 of the second image 161.

The first image portion 152 of the first image 151 is defined by a first sub-volume of the first in-use field of view volume 114. The second image portion 153 of the first image 151 is defined by a second sub-volume of the first in-use field of view volume 114.

The first image portion 162 of the second image 161 is defined by a first sub-volume of the second in-use field of view volume 124. The second image portion 163 of the second image 161 is defined by a second sub-volume of the second in-use field of view volume 124.

The new image 171 is defined by the combined volume of the a first sub-volume of the first in-use field of view volume 114 and the second sub-volume of the second in-use field of view volume 124.

In the illustrated example, the first in-use field of view volume 114 is different to the first unobstructed field of view volume 112 because the first in-use field of view volume 114 does not include a portion 116 of a second sub-volume of the first unobstructed field of view volume 112. This portion 116 in this example extends from the middleground 132 to the background 134 but is not present in the foreground 130. The second image portion 153 of the first image 151 is defined by a foreground portion (only) of the second sub-volume of the first unobstructed field of view volume 112. The second camera 120 is positioned within the portion 116 of the second sub-volume of the first unobstructed field of view volume 112, in the middleground 132.

In the illustrated example, the portion 116 is defined as the volume behind the object 140 relative to the first camera 110.

In this example, but not necessarily all examples, the second camera 120 is behind the object 140 and is not therefore visible in the first image portion 152 and is not visible to the first camera 110.

Where reference is made to an or the object 140 it should be appreciated that the object may be a single entity or multiple entities. Where an object is multiple entities some or all of these entities may overlap in a field of view and/or they may be distinct and separate in a field of view. Also where reference is made to an or the unwanted second image portion 153 it should be appreciated that the unwanted second image portions 153 may be one portion corresponding to one entity or multiple overlapping entities in a field of view and/or may be multiple portions corresponding to distinct and separate entities in a field of view. The term unwanted second image portion 153 may thus refer to one or more unwanted second image portions.

In the illustrated example, the first image 151 illustrated in FIG. 4B comprises a first image portion 152 and an unwanted second image portions 153 that includes the object 140. The composite image 171 is created by the controller 102 by replacing the unwanted second image portion 153 of the first image 151 including the object 140 with the second image portion 163 of the second image 161 that does not include the object 140.

This replacement may, for example be achieved by image processing the first image 151 and the second image 161 to align, in register, the first image 151 and second image 161. This may, for example be achieved by identifying interest points within the images 151, 161 and aligning the patterns of interest points in the images to achieve maximum local alignment.

The controller 102 may be configured to find automatically, by local interest point matching with or without the use of homographies, portions of the first image 110 and the second image that have corresponding image features and thereby defining the first image portion 152 of the first image 110 and the first image portion 162 of the second image 120.

The unwanted second image portion 153 of the first image 110 is defined automatically by the controller 102 as that part of the first image 110 that is not the first image portion 152 of the first image 110.

The replacement second image portion 163 of the second image 120 is defined automatically by the controller 102 as that part of the second image 120 that is not the first image portion 162 of the second image 120.

In this example, but not necessarily all examples, the unwanted second image portion 153 is the area of the first image where there is no local alignment of interest points between the first and second images and may be treated as a putative obstruction in the first image 110. However, other approaches may be used to detect an unwanted second image portion 153. For example, pattern recognition may be used.

As an alternative of additional step, a depth sensor 200 may be used to determine the depth of features in the first image 110. A foreground object may be treated as an obstructing object 140 and the portion of the first image corresponding to the foreground object may be treated as the unwanted second image portion 153 of the first image 110.

The controller 102 then creates the composite image 171 by replacing the unwanted portion 153 of the first image 151 with the second image portion 163 of the second image 161.

The resultant composite image 171 may be processed to blend the interface between the first portion 152 of the first image 110 and the second image portion 163 of the second image 120.

The produced composite image 171 is therefore a simulation of an unobstructed image (notional image 117 in FIG. 3A) defined by the first unobstructed field of view volume 112 and is an unobstructed scene from perspective of first camera 110.

In the example illustrated, but not necessarily all example, a synchronisation system 104, which may be located in the cameras 110, 120 and/or the controller 102 is used to maintain synchronization between the cameras 110, 120. In this example the synchronisation system 104 ensures that the first image 151 and second image 161 are captured simultaneously. However, in other situations or implementations simultaneous image capture does not occur.

It may be desirable to use simultaneous capture if the captured scene is changing because of moving objects or changing light conditions for example. In examples where the captured scene is unchanging the first image 151 and second image 161 may be captured at different times.

In some examples it may be desirable to process the first portion 152 of the first image 110 and/or the second image portion 163 of the second image 120 so that in the resultant composite image 171 the boundaries between the first portion 152 of the first image 110 and the second image portion 163 of the second image 120 are not visible to a human at normal resolution. For example image characteristics (like luminosity, colors, white balance, sharpness etc) may be varied.

In some examples it may be desirable to process the first portion 152 of the first image 110 and/or the second image portion 163 of the second image 120 so that the resultant composite image 171 has a common perspective (viewing point). Typically the second image portion 163 of the second image 120 is processed so that it appears to be viewed from 110 along the first optical axis 113 rather than from 120 along the second optical axis 213 and so that it has a scale that matches the first image 110.

There may be ambiguity concerning where to position an image feature that is in the second image portion 163 of the second image 120 because it has been viewed from only the perspective of the second camera 120 and may lie anywhere along a line of sight from the second camera 120. It may therefore be desirable to collect additional information to resolve this ambiguity. It may for example be desirable to position the image feature relative to the first camera 110 by positioning the image feature at an orientation (bearing) relative to the second camera 120 and by positioning the second camera 120 at a vector displacement relative to the first camera 110.

The positioning of the image feature relative to the second camera 120 may, for example, be achieved using a depth detector 200. In one example, the depth detector 200 enables stereoscopy using the second camera 120. The second camera may, for example, be in a stereoscopic arrangement comprising an additional camera with a different perspective, for example, by being horizontally displaced or the second camera may take two images from horizontally displaced positions. The relative movement of the image feature between the two images captured from different perspectives (the parallax effect) together with knowledge of the separation of the camera(s) capturing the images allows the distance to the object corresponding to the image feature to be estimated. In addition the scene may be painted with a non-homogenous pattern of symbols using infrared light and the reflected light measured using the stereoscopic arrangement and then processed, using the parallax effect, to determine a position of the object corresponding to the image feature.

The vector displacement of the second camera 120 from the first camera 110 may be achieved in any number of ways. The position of the second camera 120 may, for example, be controlled by the controller 102 so that its relative position from the first camera 110 is known. Alternatively positioning technology may be used to position the second camera 120 (and possibly the first camera 110). This may, for example, be achieved by trilateration or triangulation of radio signals transmitted from different reference radio transmitters that are received at the second camera 120 (and possibly the first camera 110).

In this way, the controller 102 may therefore be configured to compensate the second image portion 163 of the second image 161 to adjust for a difference in scale and/or perspective between the first image 151 and the second image 161 so that a scale and/or perspective of the first image portion 152 of the first image 151 matches a scale and/or perspective of the second image portion 163 of the second image 161.

In some but not necessarily all examples, the controller 102 comprises a warning system 106 configured to produce a warning when movement within the second in-use field of view volume 124 is detected. This warning alerts the user of the system 100 to the fact that the captured second image 120 may be unsuitable for replacement of the first image part 153 of the first image 110.

In the example of FIG. 2, an object 140 is located between the first camera 110 and the second camera 120. This object 140 lies within the first field of view 111 but not within the second field of view 121. The object 140 may be an unwanted obstruction to a desired image.

The new image 171 has had at least the object 140 removed from the first image 110 and replaced at least that portion of the first image 110 including the object 140 with at least a portion of the second image 120.

Where the new image 171 is a composite image, then in some examples only that portion 153 of the first image 110 that corresponds to the object 140 is removed from the first image 110 and replaced by only a second image portion 163 of the second image 120 that corresponds in size to the portion 153 of the first image 110 removed.

The controller 102 may, in some examples, be configured to detect a foreground object 140 in the first unobstructed field of view volume 112 excluding or potentially excluding an obstructed portion 116 of the first unobstructed field of view volume 112 of the first camera 110 from the first in-use field of view volume 114 of the first camera 110.

This object detection may be used to select the boundary between the first image portion 152 of the first image 110 (which is retained) and the second image portion 153 of the first image 110 (which is replaced).

This object detection may also be used to automatically configure the second camera 120 so that it captures a second image 120 that comprises a second image portion 163 that is suitable for replacing the second image portion 153 of the first image 110.

Object detection may be achieved in any suitable manner. The object detection may, for example, use a depth sensor 200 or may use image processing. Image processing routines for object detection are well documented in computer vision textbooks and open source computer code libraries.

In some, but not necessarily all examples, the controller 102 is configured to automatically control the second camera 120 in dependence upon the obstructed portion 116 of the first unobstructed field of view volume 112. It may for example, change an optical or other zoom and/or change an orientation of the second cameras via tilt or pan and/or change a position of second camera 120 in dependence upon the obstructed portion 116 of the first unobstructed field of view volume 112 so that the second in-use field of view volume 124 images the obstructed portion 116 of the first unobstructed field of view volume 112.

It will be appreciated that the system 100 may comprise: a first camera 110 configured to capture a foreground 130, middleground 132 and background 134 of a scene with a relatively narrow field of view as a first image 151; a second camera 120 configured to capture only the mid ground 132 and background 134 of the scene with a relatively wide field of view as a second image 161; and a controller 102 configured to define a new image 171 by using at least a second image portion 163 of the second image 161 captured by the second camera 120 instead of at least a portion of the first image 151 captured by the first camera 110.

It will be appreciated that the controller 102 may be configured to define a new image 171 by using, instead of at least a second image portion 153 of a first image 151 including a foreground 130 of a scene, at least a second image portion 163 of a second image 161 not including the foreground 130 of the scene, wherein the first image 151 is provided by a first camera 110 and has a relatively narrow first field of view 111 and includes a foreground 130, a middleground 132 and a background 134 of a scene, and wherein the second image 161 is provided by a second camera 120, different to the first camera 110, and has a relatively wide second field of view 121 and has only the mid ground 132 and the background 134 of the scene.

In the example illustrated in FIG. 7, the second camera 120 moves along a path, in this example a circle. The path may be a predetermined path or it may be otherwise defined. It may for example be variable.

In this example, but not necessarily all example, the second camera 120 is mounted on a rail system 210. In the example of FIG. 7, the rail system 210 comprises one or more running rails 211 along the path on which the second camera 120 is mounted for movement. In other examples, (mechanical) rails are not used, and the second camera may be on wheels, fly (as a drone) etc, perhaps tracking a line on the around or a path defined in some other way. This is similar to having “virtual rails”.

The controller 102 is configured to automatically control a position of the second camera 120 on the path. The controller is not illustrated in FIG. 7 but this adaptation of the second camera 120 is illustrated as an optional feature in FIG. 1 by using dashed lines.

In this example, but not necessarily all examples, the path is arranged as a circle with the first camera 110 at or near the centre of the circle. The area between the path and the first camera 110 defines a production crew area 212. If a member of the production crew or their equipment is in the area 212, then the controller 102 can detect their presence automatically and automatically reposition the second camera 120 or one of many second cameras 120 so that the image of the production crew (the unwanted portion 153 of the first image 110) can be replaced by the second image portion 163 of the second image 120 captured by the repositioned second camera 120.

In the example of FIG. 7 the system 100 comprises a first plurality of first cameras 110 mounted with overlapping respective first unobstructed field of view volumes and configured to simultaneously capture first images 110 defined by respective overlapping first in-use field of view volumes.

In the example illustrated there are 8 first cameras 110 each mounted so that their first optical axis 113 lie in the same horizontal plane but are angularly separated in that plane by 45°. The horizontal component of the field of view 111 of each of the first cameras 110 is greater than 45°. The first images 110 captured by the first cameras 110 may be combined to create a 360° panoramic image. The 360° panorama is with respect to the horizontal plane of the first cameras 110.

The controller 102 (not illustrated in FIG. 7) is configured to define a new image 171 by using at least the second image portion 163 of the second image 161 captured by the second camera 120 instead of at least a portion of any one of the first images 151 captured by the plurality of first cameras 110. The second camera 120 may, for example, be automatically positioned as described above to enable removal of a foreground object 140 from the panoramic image.

In other examples, additional second cameras 120 may be used.

An obstructing object 140 may be within the field of view 121 of multiple first cameras 110 simultaneously and may need to be removed from multiple first images 151 captured by different first cameras 110 by using the same second image 161 captured by a second camera 120 for each of those multiple first images 151.

In other examples, additional second cameras 120 may be used. An obstructing object 140 may be within the field of view of multiple cameras simultaneously and may need to be removed from multiple first images 151 captured by different first cameras 121 by using a different second image 161 captured by a different second camera 120 for each of those multiple first images 151.

In other examples, additional first camera configurations may be used. For example, some first cameras 110 may be mounted so that their first optical axis 111 lies outside the horizontal plane and is angularly separated from that that plane by X°. The vertical component of the field of view 111 of each of the first cameras is greater than X°. The first images 110 captured by the first cameras 110 may be combined (vertically and horizontally) to create a 3D panoramic image.

FIG. 8 illustrates an example of the system 100 that has multiple first cameras 110 and multiple second cameras 120. In some examples, it may be desirable to replace more than one object that is captured in a first image 110. It may therefore be desirable to replace multiple distinct second image portions 153 of the first image 110 by respective second distinct second image portions 163. The respective second distinct second image portions 163 may be portions from the same second image 120 captured by a single second camera 120. Alternatively, the respective second distinct second image portions 163 may be portions from different second images 120 captured simultaneously by different second cameras 120.

The system 100 may therefore comprise:

a first camera 110 configured to have a first unobstructed field of view volume 112 and to capture a first image 151 defined by a first in-use field of view volume 114;

a second camera 120 configured to capture a second image 161 defined by a second in-use field of view volume 124, and positioned at a first position within the first unobstructed field of view volume 112 of the first camera 110 but not within the first in-use field of view volume 114 of the first camera 110 in front of an obstructing object 140;

a third camera configured to capture a third image defined by a third in-use field of view volume, and positioned at a second position, different to the first position and within the first unobstructed field of view volume 112 of the first camera 110 but not within the first in-use field of view volume 114 of the first camera 110 in front of the obstructing object 140;

a controller 102 configured to define a new image 171 by using at least a second image portion 163 of the second image 161 captured by the second camera 120 and also at least a third image portion of the third image captured by the third camera instead of at least a portion of the first image 151 captured by the first camera 110.

While a new image has been described above as replacing at least the second image portion 153 of the first image 110 with at least the second image portion 163 of the second image 120, it should be understood that this encompasses a new image in which only the second image portion 153 of the first image 110 is replaced with at least the second image portion 163 of the second image 120 and also encompasses a new image in which all of the first image 110 is replaced with at least the second image portion 163 of the second image 120.

While a composite image has been described above as replacing the second image portion 153 of the first image 110 with only a second image portion 163 of the second image 120, it should be understood that in other examples, a composite image 171 is formed by replacing the second image portion 153 of the first image 110 with at least the second image portion 163 of the second image 161, which may be the whole of the second image 120.

Implementation of a controller 102 may be as controller circuitry. The controller 102 may be implemented in hardware alone, have certain aspects in software including firmware alone or can be a combination of hardware and software (including firmware).

The controller 102 may be distributed across multiple apparatus in the system 100 or may be housed in one apparatus in the system 100.

As illustrated in FIG. 9 the controller 102 may be implemented using instructions that enable hardware functionality, for example, by using executable instructions of a computer program 320 in a general-purpose or special-purpose processor 300 that may be stored on a computer readable storage medium (disk, memory etc) to be executed by such a processor 300.

The processor 300 is configured to read from and write to the memory 310. The processor 300 may also comprise an output interface via which data and/or commands are output by the processor 300 and an input interface via which data and/or commands are input to the processor 300.

The memory 310 stores a computer program 320 comprising computer program instructions (computer program code) that controls the operation of the controller 102 when loaded into the processor 300. The computer program instructions, of the computer program 320, provide the logic and routines that enables the apparatus to perform the methods illustrated and described in relation to the preceding Figs. The processor 300 by reading the memory 310 is able to load and execute the computer program 320.

The controller 102 may therefore comprise:

at least one processor 300; and

at least one memory 310 including computer program code,

the at least one memory 310 and the computer program code configured to, with the at least one processor 300, cause the controller at least to perform:

creating a new image by using, instead of at least a portion of a first image including the foreground of a scene, at least a second image portion of a second image not including the foreground of the scene, wherein the first image is provided by a first camera and has a relatively narrow first field of view and includes a foreground, a middleground and a background of a scene, and wherein the second image is provided by a second camera different to the first camera and has a relatively wide second field of view and has only the middleground and the background of the scene.

The controller 102 may therefore comprise:

at least one processor 300; and

at least one memory 310 including computer program code,

the at least one memory 310 and the computer program code configured to, with the at least one processor 300, cause the controller at least to perform:

creating a new image by using, instead of at least a portion of a first image including the foreground of a scene, at least a second image portion of a second image not including the foreground of the scene, wherein the first image includes a foreground, a middleground and a background of a scene, and wherein the second image incudes only the middleground and the background of the scene, and

compensating the second image portion of the second image to adjust for a difference in a position and a field of view for image capture of the first image and a position and a field of view for image capture of the second image.

As illustrated in FIG. 10, the computer program 320 may arrive at the controller 102 via any suitable delivery mechanism 322. The delivery mechanism 322 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 320. The delivery mechanism may be a signal configured to reliably transfer the computer program 320. The controller 102 may propagate or transmit the computer program 320 as a computer data signal.

Although the memory 310 is illustrated as a single component/circuitry it may be implemented as one or more separate components/circuitry some or all of which may be integrated/removable and/or may provide permanent/semi-permanent/dynamic/cached storage.

Although the processor 300 is illustrated as a single component/circuitry it may be implemented as one or more separate components/circuitry some or all of which may be integrated/removable. The processor 300 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A system comprising:
at least a first camera configured to have a first unobstructed field of view volume and to capture a first image defined by a first in-use field of view volume;
at least a second camera configured to capture a second image defined by a second in-use field of view volume, and positioned within the first unobstructed field of view volume of the first camera;
a controller configured to define a new image by using at least a second image portion of the second image captured by the second camera instead of at least a portion of the first image captured by the first camera, and
wherein the controller is configured to detect a foreground object in the first unobstructed field of view volume excluding or potentially excluding an obstructed portion of the first unobstructed field of view volume of the first camera from the first in-use field of view volume of the first camera.

2. A system as claimed in claim 1, wherein the new image is a composite image comprising at least a first image portion of the first image captured by the first camera and at least a second image portion of the second image captured by the second camera.

3. A system as claimed in claim 2, wherein the first image comprises the first image portion and an unwanted portion and wherein the controller is configured to define the composite image by replacing the unwanted portion of the first image with the second image portion of the second image.

4. A system as claimed in claim 3, wherein the controller is configured to cause:
image processing of the first image and the second image to align in register the first image and the second image;
image processing to identify an unwanted portion of the first image and to identify the second image portion of the second image that corresponds to the unwanted portion of the first image; and
creating the composite image by replacing the unwanted portion of the first image with the second image portion of the second image.

5. A system as claimed in claim 2, wherein the controller is configured to compensate a second image portion of the second image to adjust for a difference in the scale and/or perspective between the first image and the second image so that a scale and/or perspective of the first image portion of the first image matches the scale and/or perspective of the second image portion of the second image.

6. A system as claimed in claim 1, wherein the new image is a simulation of an unobstructed image defined by the first unobstructed field of view volume and represents an unobstructed scene from a perspective of the first camera.

7. A system as claimed in claim 1 further comprising a synchronisation system configured to enable simultaneous capturing of the first image and the second image.

8. A system as claimed in claim 1, further comprising a warning system configured to warn of movement within the second in-use field of view volume.

9. A system as claimed in claim 1, wherein the first in-use field of view volume is different to the first unobstructed field of view volume because the first in-use field of view volume does not include a middleground portion of a sub-volume of the first unobstructed field of view volume, wherein the second camera is positioned within the middleground portion of the sub-volume of the first unobstructed field of view volume, wherein the portion of the first image, replaced by the second image portion of the second image, is defined by a foreground portion of the sub-volume of the first unobstructed field of view volume and wherein the second image portion of the second image is defined by a sub-volume of the second in-use field of view volume.

10. (canceled)

11. A system as claimed in claim 1, wherein the controller is configured to automatically control the second camera in dependence upon the obstructed portion of the first unobstructed field of view volume and/or automatically control a position of the second camera in dependence upon the obstructed portion of the first unobstructed field of view volume.

12. A system as claimed in claim 1, wherein the controller is configured to control a position of the second camera along a path, wherein the path defines between the first camera and the rail system an area for occupancy by a production crew.

13. A system as claimed in claim 1 further comprising a first plurality of first cameras mounted with overlapping respective first unobstructed field of view volumes and configured to simultaneously capture first images defined by respective overlapping first in-use field of view volumes, wherein the controller is configured to define a new image by using at least the second image portion of the second image captured by the second camera instead of at least a portion of any one of the first images captured by the plurality of first cameras.

14. A system comprising as claimed in claim 1 further comprising:
a third camera configured to capture a third image defined by a third in-use field of view volume, and positioned at a second position, different to a first position of the second camera and within the first unobstructed field of view volume of the first camera but not within the first in-use field of view volume of the first camera in front of an obstructing object; and
wherein the controller is configured to define a new image by using at least a second image portion of the second image captured by the second camera and also at least a third image portion of the third image captured by the third camera instead of at least a portion of the first image captured by the first camera.

15. A controller configured to define a new image by using, instead of at least a portion of a first image including the foreground of a scene, at least a second image portion of a second image not including the foreground of the scene, wherein the first image is provided by a first camera and has a relatively narrow first field of view and includes a foreground, a middleground and a background of a scene, and wherein the second image is provided by a second camera different to the first camera and has a relatively wide second field of view and has only the middleground and the background of the scene.

16. A controller configured to define a new image by using, instead of at least a portion of a first image including the foreground of a scene, at least a second image portion of a second image not including the foreground of the scene, wherein the first image includes a foreground, a middleground and a background of a scene, and wherein the second image incudes only the middleground and the background of the scene, wherein the controller is configured to compensate the second image portion of the second image to adjust for a difference in a position and a field of view for image capture of the first image and a position and a field of view for image capture of the second image.

17. A method comprising: creating a new image by using, instead of at least a portion of a first image including the foreground of a scene, at least a second image portion of a second image not including the foreground of the scene, wherein the first image is provided by a first camera and has a relatively narrow first field of view and includes a foreground, a middleground and a background of a scene, and wherein the second image is provided by a second camera different to the first camera and has a relatively wide second field of view and has only the middleground and the background of the scene.

18. A method comprising creating a new image by using, instead of at least a portion of a first image including the foreground of a scene, at least a second image portion of a second image not including the foreground of the scene, wherein the first image includes a foreground, a middleground and a background of a scene, and wherein the second image incudes only the middleground and the background of the scene, and
compensating the second image portion of the second image to adjust for a difference in a position and a field of view for image capture of the first image and a position and a field of view for image capture of the second image.

19. A computer program that, when run on a processor, perform the method of claim 17.
